(19) United States
(12) Patent Application Publication
(10) Pub. No.: US 2014/0255729 A1
(43) Pub. Date: Sep. 11, 2014

(54) MICROBIAL FUEL CELL HAVING ELECTRICALLY CONDUCTIVE FOAM ELECTRODE

(71) Applicant: HONEYWELL INTERNATIONAL INC., Morristown, NJ (US)

(72) Inventor: WILLIAM SHERIDAN, NAPERVILLE, IL (US)

(73) Assignee: HONEYWELL INTERNATIONAL INC., Morristown, NJ (US)

(21) Appl. No.: 14/041,230

(22) Filed: Sep. 30, 2013

Related U.S. Application Data
(60) Provisional application No. 61/772,834, filed on Mar. 5, 2013.

(51) Int. Cl. H01M 4/86; H01M 8/16

(52) U.S. Cl. CPC H01M 4/8605; H01M 8/16
USPC 429/2

(57) ABSTRACT

A microbial fuel cell includes an anode and a cathode in at least one compartment. A wastewater inlet provides a wastewater flow to the anode and an electron receptor inlet provides oxygen or other electron-acceptor to the cathode. Pollutant-degrading microorganisms are in contact with the anode. A conduit electrically connects the anode to the cathode through an external circuit. At least the anode includes a polymeric foam substrate providing flow-through having electrically conductive material interspersed within, or electrically conductive material is attached to the polymeric foam substrate by a binder or by chemical bonds.

### CROSS REFERENCE TO RELATED APPLICATIONS

This application claims the benefit of Provisional Application Ser. No. 61/772,834 entitled “MICROBIAL FUEL CELL HAVING ELECTRICALLY CONDUCTIVE FOAM ELECTRODE” filed Mar. 5, 2013, which is herein incorporated by reference in its entirety.

### FIELD

Disclosed embodiments relate to microbial fuel cells.

### BACKGROUND

A microbial fuel cell (MFC) or biological fuel cell is a bio-electrochemical system that generates an electrical current by mimicking bacterial interactions found in nature. A typical microbial fuel cell includes anode and cathode compartments (or chambers) separated by a cation specific membrane. In the anode compartment, fuel is oxidized by the microbes (i.e., bacteria), generating carbon dioxide (CO₂), electrons and protons. Electrons are transferred to the cathode compartment through an external electric circuit, while protons are transferred to the cathode compartment through the membrane. Electrons and protons are consumed in the cathode compartment, combining with oxygen to form water, or, under certain conditions, forming hydrogen peroxide.

Organic materials can be used as the fuel for the MFCs, where the bacteria oxidize the organic materials. Conventional MFCs have focused primarily on solid carbon-based electrodes using graphite, activated carbon, or carbon fibers. In addition, non-corrosive metals such as stainless steel and gold have also been used as anodes in MFC's, but present a high cost of development for pilot and commercial-scale MFCs.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments include bioelectrodes for anodes and optionally cathodes for microbial fuel cells (MFCs) which comprise reticulated foam providing added porosity as compared to conventional solid bioelectrodes. Disclosed bioelectrodes as anodes allow microbial biofilms to more effectively colonize the anode and efficiently transport electrons through the electrical circuit to the cathode, improving the overall efficiency of the MFC.

The term “reticulated foam” as used herein refers to a foam material having a mesh like structure that does not readily absorb water, such as reticulated hydrophobic polyurethane foam in particular embodiments. Disclosed bioelectrodes include a polymeric foam substrate providing flow-through having an electrically conductive material interspersed within, or electrically conductive material attached to the polymeric foam substrate by a binder or chemically bonded to the polymeric foam substrate.

### BRIEF DESCRIPTION OF THE DRAWINGS

FIG. 1 is a depiction of an example 2-compartment MFC having an anode which includes a polymeric foam substrate material providing flow-through having electrically conductive material interspersed within, or electrically conductive material attached to the polymeric foam substrate by a binder or by chemical bond, and a cathode, according to an example embodiment.

FIG. 2 is a depiction of an example single compartment MFC having an anode which includes a polymeric foam substrate providing flow-through having electrically conductive material interspersed within, or electrically conductive material attached to the polymeric foam substrate by a binder or by chemical bond, and a cathode, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

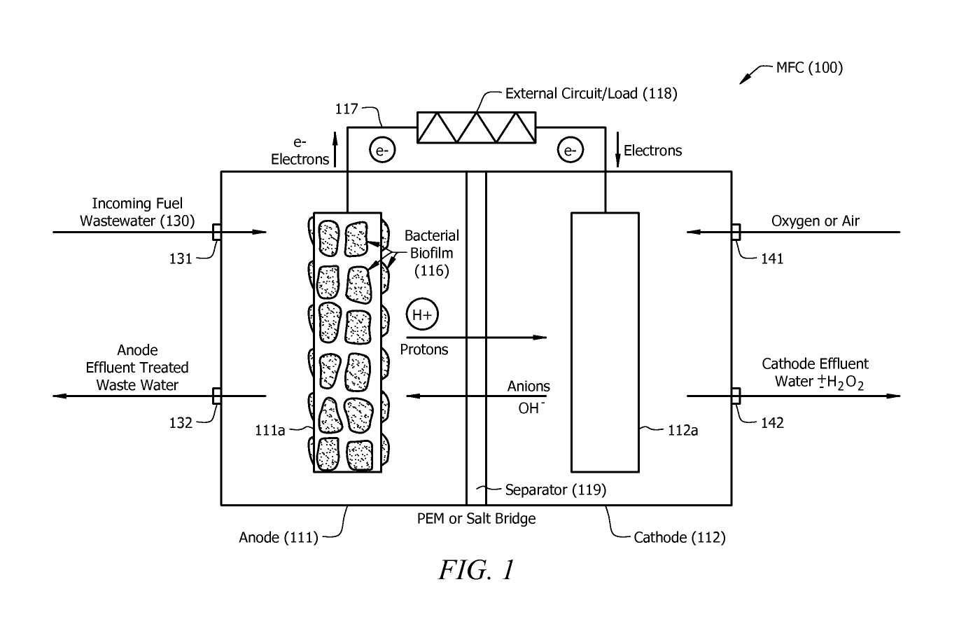

FIG. 1 is a depiction of an example 2-compartment MFC 100 having a disclosed bioelectrode as an anode 111a shown including a polymeric foam substrate material providing flow-through having electrically conductive material interspersed within, or electrically conductive material attached to the polymeric foam substrate by a binder or by chemical bond, according to an example embodiment. The anode 111a is within an anode compartment (or chamber) 111 with microorganisms such as bacteria and/or algae shown as a biofilm 116 in contact with the anode 111a, being both on and within the open-porous regions of the anode 111a. The cathode 112a is shown as a conventional cathode. However, the cathode 112a can be a disclosed bioelectrode including a polymeric foam substrate material providing flow-through and having electrically conductive material.

The open-pore polymeric foam structure can be provided in a range of controlled pore sizes that contain void volumes of at least 50% up to about 98% and surface areas per unit volume of up to 2,000 ft²/ft³. The high porosity reduces flow-through resistance and provides efficiency at colonizing microorganisms such as bacteria.

However, typically, the open-pore polymeric foam will have fewer pores per inch (10-15 ppi; therefore larger pores) with corresponding lower surface area, up to 200-300 ft²/ft³. Generally, disclosed anodes for containing biofilms will have a surface area approximately 200-300 ft²/ft³, with disclosed flow-through cathodes (generally not containing biofilms) having a surface area from 300 ft²/ft³ to 2,000 ft²/ft³.

In the 2-compartment embodiment shown in FIG. 1, the cathode 112a in the cathode compartment 112 is separated from the anode 111a in the anode compartment 111 by a cation specific membrane/separator. The separator 119 also prevents the flow of microorganisms and biodegradable material from the anode compartment 111 to the cathode compartment 112. The separator 119 can also limit or prevent the flow of gas or liquids between the anode compartment 111 and the cathode compartment 112. An electrically conductive conduit (e.g., a metal wire(s)) 117 for conducting electrical current electrically connects the anode 111a to the cathode 112a through an external circuit (load) 118.

FIG. 1 shows organic matter from incoming fuel wastewater 130 introduced into anode chamber 111 from a wastewater inlet 131 being decomposed by microorganisms (e.g., bacteria) of the biofilm 116 to anode effluent treated wastewater such as including carbon dioxide (CO₂) which flows out of anode outlet 132, and generates protons (H+) which are transported through the separator 119 to the cathode chamber 112 and electrons which are coupled to the external circuit 118. In the cathode compartment 112, electrons entering via the external circuit 118 reduce oxygen (O₂, such as from air) or other electron-acceptors provided from an electron receptor inlet 141 in the cathode compartment 112 into hydroxide ions (OH⁻) that flow-through separator 119 to the anode compartment 111 and water and/or H₂O₂ are generated which flow out of cathode outlet 142.

As used herein, an electrically conductive material for a disclosed bioelectrode refers to a material having a 25° C. electrical conductivity of at least 10⁻² S/cm, typically being at least 10⁻¹ S/cm. For embodiments where the electrically conductive material is interspersed within the polymeric foam substrate the electrical conductivity of at least 10⁻² S/cm is a bulk electrical conductivity value. For embodiments where the polymeric foam substrate has electrically conductive material attached thereto by a binder or by chemical bonds the polymeric foam substrate will generally be a dielectric with the attached electrically conductive material providing the electrically conductive surface for operation as a bioelectrode providing an electrical conductivity of at least 10⁻² S/cm.

The polymer is generally a dielectric (having a 25° C. electrical conductivity<10⁻⁸ S/cm) and can be a hydrophobic polymer or hydrophobic polymer composite. One example dielectric polymer is open-reticulated hydrophobic polyurethane foam (PUF). Hydrophobic foams such as polyether foams (e.g., hydrophobic polyether cross-linked polyurethanes) are water stable and thus do not degrade in water environments such as hydrophilic foams including polyester foams which generally dissolve in water. Accordingly, hydrophobic polymer foams have significantly longer functional life spans in water environments as compared to hydrophilic foams. Commercially available hydrophobic polyurethane foams include those marketed under the trademarks Crest Foam and FoamEx, and are made available from Crest Foam, Moonachie, N.J., USA and FoamEx, Eddystone, Pa., USA.

Polyurethane including polyurethane foams are generally hydrophilic. As known in the art, an open-reticulated hydrophobic PUF can be prepared from a polyether polyol using a surfactant, such as a hydrophobicity inducing surfactant (See, e.g., U.S. Pat. No. 6,747,068 to Kelly). Typically, hydrophobicity inducing surfactants are polysiloxane-polyalkylene oxide copolymers, usually the non-hydrolyzable polysiloxane-polyalkylene oxide copolymer type. Hydrophobicity inducing surfactants include: Goldschmidt Chemical Corp. of Hopewell, Va. products sold as B8110, B8229, B8232, B8240, B8870, B8418, B8462; Organo Silicons of Greenwich, Conn. products sold as L6164, L600 and L626; and Air Products and Chemicals, Inc. products sold as DC5604 and DC5598. Polyisocyanates can be added at a polyisocyanate index of from about 75 to about 125. Toluene diisocyanate is an example polyisocyanate, such as at a TDI index of about 100.

For PUFs, hydrophobicity can be increased by increasing the fraction of Propylene Oxide (PO) relative to Ethylene Oxide (EO) in the polyol mixture. Increasing the PO:EO wt. % ratio to 50:50, 60:40, or 70:30 produces increasingly more hydrophobicity, but can make the foam more brittle and thus more likely to tear.

As used herein, a “hydrophobic” polymer foam such as a hydrophobic PUF refers to a foam material that is water impermeable in that it resists the flow of water into or through the solid foam material, when a water column of up to one inch height exerts pressure on the foam for at least 60 minutes. For example, disclosed hydrophobic polymer foam materials can resist the flow of water into or through the foam for at least 90 minutes up to 24 hours or more.

As noted above, the foam material can be coated or impregnated or chemically reacted to form a chemical bond with an electrically-conductive material. Generally any material which is electrically conductive which also is compatible with the microorganisms in the biofilm 116 may be used. Compatible with the microorganisms refers to a material which does not kill the microorganisms or interfere with the microorganisms catalyzing the decomposition of the organic matter in the incoming fuel wastewater 130.

The electrically conductive material can be an electrically conductive metal or metal alloy, or a non-metal such as an electrically conductive carbon composition, or an electrically conductive polymer. One example metal is titanium. Any carbon which is electrically conductive may generally be used. Classes of conductive carbon include carbon black, graphite, graphene, graphite oxide, carbon nanotubes, bead carbons, granular powdered grade carbon materials, and electrically conductive synthetic carbon materials. Another form of electrically conductive carbon comprises a matrix of expanded graphite having pores which pass through the carbon matrix. Regarding electrically conductive polymers, conjugated polymers, such as polythiophenes or poly(3,4-ethylenedioxythiophene) (PEDOT), can be used to enhance properties of electrical conductance for electrodes in disclosed MFCs. When used for the anodes in MFC's with specialized anode-reducing bacteria (ARB), disclosed electrically conductive foam-based anode and/or cathodes significantly enhance the performance of MFCs.

Honeywell International discloses effective methods to coat PUFs with adsorbent materials using polymeric binders (see U.S. Pat. Nos. 5,580,770 & 6,395,522) such that the powdered activated carbon (PAC) is not blinded (made less adsorptive) by the binding agent used to fix the PAC to the PUF upon manufacture. U.S. Pat. No. 6,395,522 to Defilippi discloses a method of making a biologically active carbon-coated polyurethane support for use in conventional biological wastewater treatment systems such as continuous stirred reactors, fixed-bed reactors and fluidized bed reactors.

Similar binding methods can be used to manufacture disclosed bioelectrodes (anodes and/or cathodes) for use in a MFC for removal of pollutants and generating electricity from wastestreams. Such binding methods comprise: (i) applying a layer of a curable dispersion of a polymeric binder onto the surface of a polymeric foam substrate; (ii) applying one or more electrically conductive materials onto the uncured polymeric binder on the polymeric foam substrate, the conductive materials accepting electrons from microorganisms in the biofilm 116 which oxidize fuel pollutants in wastewater 130; (iii) allowing the binder to cure, wherein the binder binds the electrically conductive materials to the surface of the substrate and has a T_{g} of lower than or equal to about 25° C.; and (iv) exposing the binder-coated substrate of (iii) to pollutant-degrading microorganisms to adhere the microorganisms to at least one of the substrate, binder or adsorbent.

In the disclosed embodiment the electrically conductive material is attached to the polymeric foam substrate by a binder, an effective binder is a material which is capable of binding the electrically conductive material to the surface of a substrate such that there is no or substantially no loss of electrical conductive capacity of the electrically conductive material bound to the foam substrate, and there is no or substantially no deactivation of the electrically conductive material by the binder. Specifically, an effective binder can be selected such that the bioelectrical circuitry of the MFC process is resistant to upset while maximizing electric current density (ampere per square centimeter, or A/cm²). Partial coating of the support is acceptable as long as the process remains resistant to upset and electrically conductive.

The binder may be selected from any type of binder known in the art, e.g., in the particulate binding art, pigment binding art or powder binding art. Examples of binders are water soluble polymers which can be crosslinked or polymerized into water insoluble forms such as natural gums, cellulose and starch derivatives, salts of alginic acids and polymers and copolymers of acrylic acid, acrylamide, vinyl alcohol and vinyl pyrrolidone.

Examples of useful organic binders which are soluble in organic solvents include cellulose esters, cellulose ethers, polymers and copolymers of vinyl esters such as vinyl acetate, acrylic acid esters, and methacrylic acid esters, vinyl monomers such as styrene, acrylonitrile and acrylamide, and dienes such as butadiene and chloroprene; natural rubber and synthetic rubber such as styrene-butadiene. Similar coating methods can be used to coat PUFs or other polymeric foam materials with electrically-conductive materials while keeping the electrically conductive material exposed to biofilms for electron conductance.

The electrically-conductive material can also be blended into the foam polymer composites prior to foaming, with or without suspension aids such as surfactants and/or polyanionic polypeptides, with the conductive material effectively impregnated into the foam matrix during foam formation and reticulation. An effective ratio can be selected which allows the resulting foam-based biosupport material to be a highly electrically conductive (e.g., maximizing A/cm²) for use as a bioelectrode.

As noted above, the electrically conductive material can be attached to the polymeric foam substrate by chemical bonds. For example, certain electrically-conductive materials (e.g., polythiophenes and poly(3,4-ethylenedioxythiophene)) can be polymerized with or chemically bonded to polymer materials having reactive end groups such as polyurethane foam substrates at concentrations which significantly increase the composite's electrical conductivity (maximizing A/cm²) for use as a bioelectrode in MFCs.

In operation, to remove wastewater pollutants and generate electricity in a MFC, a disclosed biologically-active anode and/or cathode is placed in a MFC reactor, such as shown in MFC 100, and a fluid stream containing pollutants (incoming fuel wastewater 130 shown in FIG. 1) is passed through the MFC 100. The biofilm 116, such as including Anode Reducing Bacteria (ARB), is within the pores and on the surface of the anode 111a, and the cathode can also include a suitable biofilm both within and thereon, but typically does not. Due to the high porosity of disclosed bioelectrodes, a high density of internal sites are available for more effective colonizing the carrier transport electrons through the electrical circuit, improving the overall efficiency of the MFC including increased electricity output per unit size and more efficient wastewater treatment as compared to conventional MFCs having non-porous bioelectrodes that only have biofilms thereon.

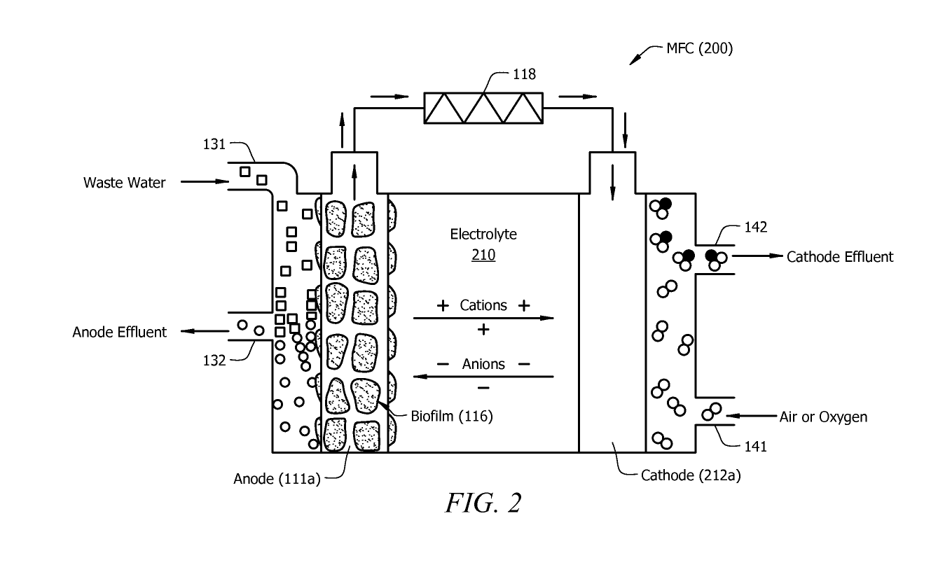

FIG. 2 is a depiction of an example single compartment MFC 200 having a disclosed anode 111a which provides flow-through and includes a polymeric foam substrate material having electrically conductive material interspersed within, or electrically conductive material attached to the polymeric foam substrate by a binder or by chemical bond, according to an example embodiment. The cathode 212a in FIG. 2 is shown as a conventional cathode. However, the cathode 212a can be a disclosed bioelectrode including a polymeric foam substrate material providing flow-through and having electrically conductive material. An electrolyte 210 is between the anode 111a and cathode 112a providing free exchange of cations and anions. In some MFC designs the electrolyte 210 can be the incoming fuel wastewater 130.

Although the anode 111a is shown side-located in FIG. 2, the anode 111a can also be centrally located with cathode(s) such as cathode 112a on one side or on multiple sides of the anode 111a. Moreover, although the cathode 212a is shown in FIG. 2 as an air cathode, the cathode can also be a submersed-cathode.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

1. A microbial fuel cell (MFC), comprising:
an anode and a cathode in at least one compartment;
a wastewater inlet in said compartment providing a wastewater flow to said anode;
an electron receptor inlet in said compartment providing oxygen or other electron-acceptor to said cathode;
pollutant-degrading microorganisms in contact with said anode, and a conduit for electrically connecting said anode to said cathode through an external circuit;
wherein at least said anode includes a polymeric foam substrate providing flow-through having electrically conductive material interspersed within, said electrically conductive material is attached to said polymeric foam substrate by a binder, or said electrically conductive material is attached to said polymeric foam substrate by chemical bonds.

2. The MFC of claim 1, wherein said at least one compartment comprises an anode compartment having said wastewater inlet with said anode therein and a cathode compartment having said electron receptor inlet with said cathode therein, and wherein said cathode compartment is separated from said anode compartment by a cation specific membrane.

3. The MFC of claim 1, wherein said at least one compartment consists of a single compartment, with an electrolyte between said anode and said cathode providing free exchange of cations and anions flow-through.

4. The MFC of claim 1, wherein said polymeric foam substrate comprises a hydrophobic polymeric foam.

5. The MFC of claim 4, wherein said hydrophobic polymeric foam comprises an open-reticulated hydrophobic polyurethane foam (PUF).

6. The MFC of claim 1, wherein said polymeric foam substrate has said electrically conductive material interspersed within.

7. The MFC of claim 1, wherein said polymeric foam substrate has said electrically conductive material attached to thereto by said binder.

8. The MFC of claim 1, wherein said polymeric foam substrate has said electrically conductive material attached thereto by said chemical bonds.

9. The MFC of claim 7, wherein said electrically conductive material comprises an electrically conductive polymer.

10. The MFC of claim 1, wherein said electrically conductive material provides a 25° C. electrical conductivity of at least 10⁻¹ S/cm.

11. A microbial fuel cell (MFC), comprising:
an anode and a cathode in at least one compartment;
a wastewater inlet in said compartment providing a wastewater flow to said anode;
an electron receptor inlet in said compartment providing oxygen or other electron-acceptor to said cathode;
pollutant-degrading microorganisms in contact with said anode, and
a conduit for electrically connecting said anode to said cathode through an external circuit;
wherein at least said anode includes an open-reticulated hydrophobic polyurethane foam (PUF) substrate providing flow-through having electrically conductive material interspersed within, said electrically conductive material is attached to said PUF substrate by a binder, or said electrically conductive material is attached to said PUF substrate by chemical bonds.
